(19) United States
(12) Patent Application Publication
(10) Pub. No.: US 2004/0242151 A1
(43) Pub. Date: Dec. 2, 2004

(54) Method for controlling mobile satellite tracking antenna system

(76) Inventor: June Ha Park, Seongnm-shi (KR)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/750,665

(22) Filed: Dec. 31, 2003

(30) Foreign Application Priority Data
May 26, 2003 (KR) 2003-33354

(51) Int. Cl. H04B 1/00

(52) U.S. Cl. 455/3.02

(57) ABSTRACT

Satellite signals are received and it is determined whether or not the satellite signals have been intercepted. A maximum variation of signal level measured through 360° rotation of the antenna is compared with a room temperature noise signal level range, when the received signals do not have a restorable level. A satellite detection mode is performed when the maximum variation of the measured signal level deviates from the room temperature noise signal level range, and rotation of each motor of the antenna is stopped when the maximum variation of the measured signal level exists in the room temperature noise signal level range.

### CROSS-REFERENCE TO RELATED APPLICATIONS

This application claims priority of Korean Application No. 10-2003-0033354, filed on May 26, 2003, the disclosure of which is incorporated fully herein by reference.

### FIELD OF THE INVENTION

The present invention relates to a mobile satellite tracking antenna system, and more particularly to a method for controlling a mobile satellite tracking antenna system.

### BACKGROUND OF THE INVENTION

Recently, as broadcasting or position tracking services via satellites have become widely used, mobile satellite tracking antennas for receiving signals sent from such satellites have been developed for movable bodies such as vehicles or ships. The satellite tracking antennas provided at movable bodies transceive radio waves with satellites for broadcasting or position tracking.

Movable bodies such as vehicles frequently change direction. Furthermore, transmitted radio waves often cannot travel through buildings surrounding the movable bodies. Therefore, mobile satellite tracking antenna systems, including mobile satellite tracking antennas, have an automatic satellite tracking apparatus which always harmonizes the direction of an antenna with the direction of a satellite.

In general, an automatic satellite tracking apparatus combines an azimuth angle control apparatus, which controls for a horizontal component (azimuth angle) of the direction of an antenna, and an elevation control apparatus which controls for an elevation of an antenna. In addition, such automatic satellite tracking apparatuses include electrical circuits such as converters and tuners.

The automatic satellite tracking apparatus having this structure operates in such a manner that it rotates an antenna by means of the azimuth angle control apparatus and the elevation control apparatus until signals are received at a maximum level. Automatic satellite tracking apparatuses having this type include an auto-threshold system disclosed in Japan Laid-Open Patent application No.P4-176992 and a vibration system disclosed in Japan Laid-Open Patent Publication No.P4-60479.

Accordingly, the direction of a vehicle having a mobile antenna is detected by a direction sensor, an azimuth angle at which an antenna faces a satellite is calculated on the basis of the moving direction of the vehicle, and the direction of the antenna is then adjusted. Also, there are many cases in which variation of a large angle close to 90° occurs within a relatively short time as a vehicle turns to the left or right, or radio waves received in a vehicle from a satellite are intercepted by telegraph poles, buildings, overpasses, trees, or mountains within a short time as the vehicle moves. In these cases, the received signal level is reduced suddenly over a short time, thereby losing satellite tracking.

In this case, the satellite is detected by rotating the antenna. Methods for detecting a satellite by means of rotating the antenna include: a closed loop method in which the antenna is continuously rotated until satellite signals are sensed; an open/closed loop mixed method in which an antenna is continuously tracked until satellite signals are sensed on the assumption that movement of vehicle is sensed by an angular velocity sensor, and an open/closed loop mixed method in which an rotated angle of a vehicle is determined by an angular velocity sensor, an antenna is reverse-rotated as much as the rotated angle, and position is corrected.

FIG. 1 is a flowchart illustrating a method for tracking a satellite by a conventional satellite signal automatic tracking mode and satellite signal detection mode. As shown in FIG. 1, when a vehicle moves in step S11, the orientation direction of an antenna does not coincide with the direction of a satellite, and thus the level of signals received by the antenna is reduced. The antenna tracks a satellite signal with the highest level by the satellite signal automatic tracking mode (step S12). Further, when signals are intercepted by a building, bridge, or tree (step S13), the satellite signal detection mode is performed (step S14). That is, when signals at a restorable level are detected, the satellite signal automatic tracking mode is performed continuously (step S12). In contrast, when signals at a restorable level are not detected, the satellite signal detection mode is repeated until signals at a restorable level are detected (step S14).

In a conventional satellite detection method, when signals at a restorable level are not detected, operations (e.g. rotation of an antenna, measurement of angular velocity, or measurement of rotated angle) are repeated until satellite signals at a restorable level are received. In this case, when a vehicle is located in a shadowed area, such as underground parking place or tunnel, in which satellite signals are intercepted for a long time, an antenna continuously rotates according to the conventional satellite detection method. This rotation causes many problems in a system, such as noise occurrence and reduction of the lifetime of a driving device. Further, even in a mixed method using an angular velocity, a system must be initialized because of the accumulated error of sensors according to simplicity/repetition operation, or an antenna must be artificially rotated at predetermined time intervals.

### SUMMARY OF THE INVENTION

Accordingly, the present invention has been made to solve the above-mentioned problems occurring in the prior art, and an object of the present invention is to provide a method for controlling a mobile satellite tracking antenna system, in which, when a vehicle moves into a shadowed area, the area is determined as a shadowed area, and then satellite track operation of an antenna is stopped, so that endurance reduction, noise occurrence, or system initialization according to unnecessary operation of the antenna can be prevented.

In order to accomplish this object, there is provided a method for controlling a mobile satellite tracking antenna system comprising the steps of: 1) detecting the level of satellite signals while rotating an antenna by one revolution when the level of signals received from a satellite is maintained at a level smaller than a predetermined size even after a predetermined time passes; and 2) when the level of satellite signals is smaller than a predetermined size and difference between a maximum level value and a minimum level value is maintained within a predetermined deviation range, determining that a movable body is located at a shadowed area and then stopping satellite tracking operation.

### BRIEF DESCRIPTION OF THE DRAWINGS

The above and other objects, features and advantages of the present invention will be more apparent from the following detailed description taken in conjunction with the accompanying drawings, in which:

FIG. 1 is a flowchart illustrating a method for tracking a satellite by a conventional satellite signal automatic tracking mode and satellite signal detection mode;

FIGS. 2a to 2c are views showing satellite signal levels according to direction in a random open area, an area blocked by a building and an underground parking place; and

FIG. 3 is a flowchart illustrating a method for controlling a mobile satellite tracking antenna system according to the present invention.

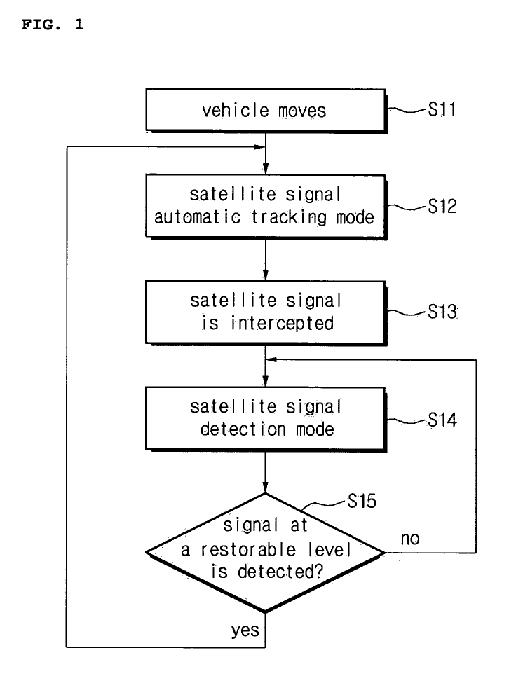

### DETAILED DESCRIPTION OF THE PREFERRED EMBODIMENTS

Hereinafter, a preferred embodiment of the present invention will be described with reference to the accompanying drawings.

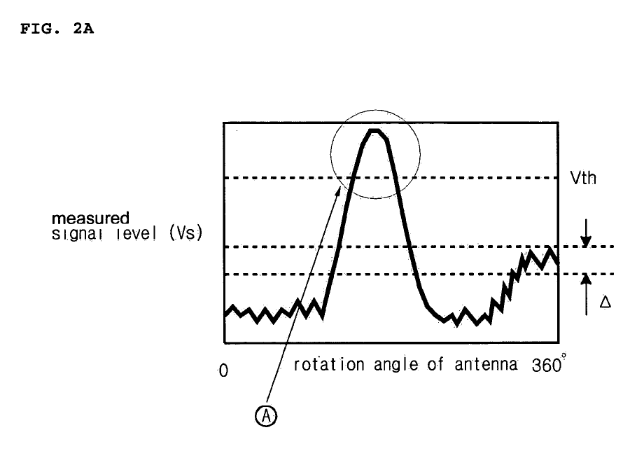

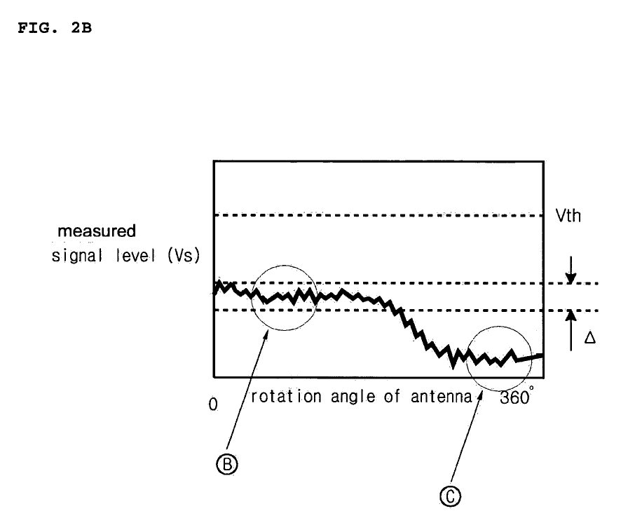

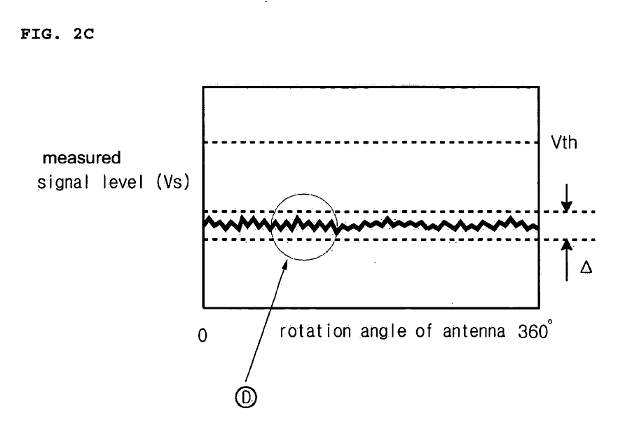

FIG. 2a to 2c are views showing satellite signal levels according to direction in a random open area, an area blocked by a building and an underground parking place.

As shown in FIG. 2a, in an open area in which artificial satellite signals can be received while a vehicle is moving, there exists a range in a rotation angle range of an antenna in which a satellite signal received by the antenna has a magnitude (Vₜₕ) that is strong enough to enable the signal to be restored while the antenna rotates through 360°. Herein, the antenna continuously tracks a satellite by a satellite signal automatic tracking mode.

As shown in FIG. 2b, when satellite signals are temporarily intercepted by a building, etc., there is not rotation angle range of an antenna in which satellite signals received by the antenna have a magnitude (Vₜₕ) that is strong enough to enable the signals to be restored even though a satellite is tracked while the antenna is rotated through 360°. In this case, when a background such as a building at a room temperature (about 290K) stands in the way of the antenna, a signal waveform with a noise power level as shown in the encircled range B appears. In contrast, when an antenna is directed at a background such as the sky at a low temperature (about 50˜100K), in which no satellite signal exists, a signal waveform with a noise power level as shown in the encircled range C appears. That is, the maximum variation of signal level measured by 360° rotation of the antenna exceeds a range of deviation of noise power levels when the background is at a room temperature. As described above, when the signal level measured through 360° rotation of the antenna has both ranges representing the room temperature background and the low temperature background in a graph, a mobile satellite tracking antenna system determines that the satellite signals are temporarily intercepted by a building, etc. Further, satellite tracking of an antenna is performed in such a manner that an automatic tracking mode is maintained or an automatic tracking mode resumes after a predetermined time passes.

Further, as shown in FIG. 2c, when a vehicle is located in a completely shadowed area such as a tunnel or underground parking garage, there exists no direction in which satellite signals received by an antenna have a magnitude (Vₜₕ) enough to enable the signals to be restored while the antenna rotates through 360°. Received signals have only a noise power level signal waveform as shown in the encircled range D representing the case in which a background at a room temperature (about 290K) exists. That is, the entire measured signal waveforms fall within the deviation range Δ of the noise power level with a room temperature background.

In other words, signals having levels as shown in the encircled range A in FIG. 2a or shown in the encircled range C in FIG. 2b are not received when the vehicle is in a completely shadowed area. As described above, if the signal level measured through 360° rotation of the antenna exists only at the room temperature background interval, then the mobile satellite tracking antenna system determines that the vehicle is located in a completely shadowed area. Further, it is continuously determined whether or not maximum variation of signals (measured by rotating an antenna by one revolution at predetermined intervals, instead of a satellite automatic tracking mode of an antenna), exceeds deviation range Δ of noise power levels.

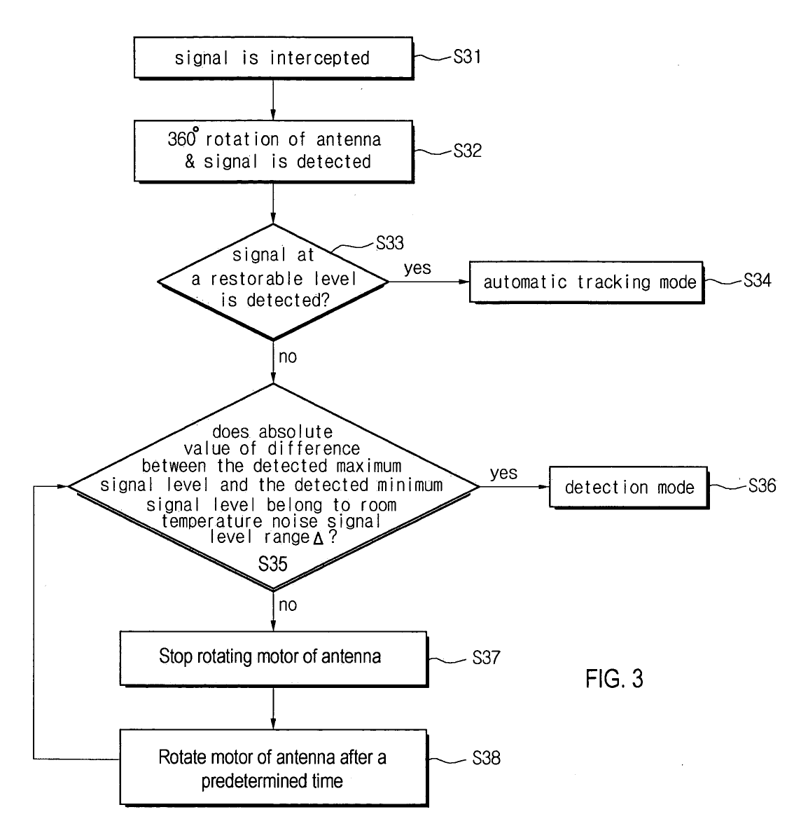

FIG. 3 is a flowchart illustrating a method for controlling a mobile satellite tracking antenna system according to the present invention. As shown in FIG. 3, satellite signals may be intercepted or blocked by an obstacle, such as a building, tree, tunnel or underground parking garage, while a vehicle moves (step S31). When the satellite signals are not received as described above and an automatic tracking mode is thus not performed, both satellite signals and noise signals are detected while rotating an antenna through 360° (step S32). In this case, the satellite signals are measured and detected by, for instance, a power detector, in the form of voltage.

Next, it is determined whether or not satellite signals, which can be restored, exist in the detected signals (step S33). From the result of determination in step S33, when the satellite signals, which can be restored, exist in the detected signals (S55-yes), the mobile satellite tracking antenna system performs an automatic tracking mode (step S34). When only room temperature background noise signals or low temperature background noise signals, which have a level smaller than a restorable level, have been detected (S33-no), it is determined whether or not an absolute value of difference between the detected maximum signal level and the detected minimum signal level, that is, the maximum variation of signal levels measured through 360° rotation of an antenna, belongs to the room temperature noise signal level range Δ (step S35). From the result of the determination in step S35—for instance, when signals deviating from the room temperature noise signal level range Δ, such as low temperature background signals, which are detected when an antenna is directed at the sky from which no satellite signals are detected, the mobile satellite tracking antenna system determines that satellite signals are being temporarily intercepted by a building, etc., and switches the automatic tracking mode into a detection mode (step S36).

In contrast, from the result of determination in step S35, for instance, when the level of detected signals belongs to the room temperature noise signal level range Δ similarly to a case of room temperature noise signals detected when a vehicle is located in a tunnel or underground parking garage, the mobile satellite tracking antenna system determines that the vehicle is located in an area (completely shadowed area) completely intercepted by the tunnel or underground parking garage, etc., and stops rotating the motor of the antenna (step S37). In this case, even though the rotation of the antenna is stopped, signal levels may be continuously measured. Further, the system operates the rotation motor of the antenna again when a predetermined time (e.g. 15 seconds, 30 seconds, or one minute) passes after the rotation of the antenna has been stopped (step S38). Simultaneously, the process proceeds to step S35 so that the system compares signal levels with each other again.

Also, when a vehicle stops for a long time or a vehicle is parked for a long time, control power of the vehicle is stopped and control of an antenna ends (step S36).

As described above, when a vehicle moves to a shadowed area, a mobile satellite tracking antenna system, according to the present invention, controls a satellite tracking operation of an antenna to be stopped, so that the antenna is not operated unnecessarily, thereby preventing reduction of endurance, noise occurrences, or additional system initialization due to unnecessary operation of the system.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A method for controlling a mobile satellite tracking antenna system, the method comprising the steps of
receiving satellite signals and sensing whether or not the satellite signals are intercepted;
performing a satellite signal automatic tracking mode when the received signals have a restorable level after rotating an antenna 360°, and comparing maximum variation of signal level measured through 360° rotation of the antenna with a room temperature noise signal level range when the received signals do not have a restorable level;
performing a satellite detection mode when the maximum variation of the measured signal level deviates from the room temperature noise signal level range, and stopping a rotation motor of the antenna from driving when the maximum variation of the measured signal level exists in the room temperature noise signal level range; and
driving the rotation motor of the antenna again when a predetermined time passes after the rotation of the antenna has been stopped, measuring signal levels while rotating the antenna 360°, and comparing the maximum variation of the measured signal level with the room temperature noise signal level range.

2. The method for controlling a mobile satellite tracking antenna system as claimed in claim 1, wherein the signal level is continuously measured even after the rotation motor of the antenna is stopped.

3. Δ method for controlling a satellite tracking system, the method comprising the steps of;
receiving satellite signals;
comparing a maximum variation of signal level measured through a 360° rotation of an antenna with a room temperature noise signal level range when the received signals do not have a restorable level; and
performing a satellite detection mode when the maximum variation of the measured signal level deviates from the room temperature noise signal level range.

4. The method of claim 3, further comprising stopping rotation of a motor of the antenna from driving when the maximum variation of the measured signal level exists in the room temperature noise signal level range.

5. The method of claim 3, further comprising, after said receiving, sensing whether or not the satellite signals are intercepted.

6. The method of claim 3, further comprising, after said receiving, performing a satellite signal automatic tracking mode when the received signals have a restorable level after rotating an antenna 360°.

7. The method of claim 3, further comprising rotating a motor of the antenna when a predetermined time passes after rotation of the antenna has been stopped.

8. The method of claim 7, further comprising measuring signal levels while rotating the antenna 360°.

9. The method of claim 8, further comprising comparing the maximum variation of the measured signal level with the room temperature noise signal level range.

10. The method of claim 3, wherein the signal level is continuously measured even after the rotation motor of the antenna is stopped.
